(19) United States
(12) Patent Application Publication
(10) Pub. No.: US 2009/0142160 A1
(43) Pub. Date: Jun. 4, 2009

(54) RAISED RECESS TRUSS HEAD SCREW

(75) Inventor: Troy Hale, Goodlettsville, TN (US)

Correspondence Address: Vierra Magen Marcus & DeNiro LLP, 575 Market Street, Suite 2500, San Francisco, CA, 94105, US

(73) Assignee: SIMPSON STRONG-TIE CO., INC., Dublin, CA (US)

(21) Appl. No.: 11/950,198

(22) Filed: Dec. 4, 2007

(51) Int. Cl. F16B 35/06; F16B 25/10; F16B 23/00

(52) U.S. Cl. 411/387.5; 411/403; 52/745.21

(57) ABSTRACT

A truss screw is disclosed for use in fastening framing members together. In embodiments, the truss screw includes a raised recess section having walls extending from a top surface of the screw head. The raised recess sinks into the back surface of a workpiece fastened to the framing members so that the workpiece may sit flat against the workpiece.

### BACKGROUND OF THE INVENTION

1. Field of the Invention

The present invention relates to a screw for use in securing steel members, and in particular to a screw having a raised, recessed head for use in securing workpieces.

2. Description of the Related Art

The head portion of a screw is required to have a certain depth in order to receive and transmit the requisite torque for driving the screw into the workpiece receiving the screw. The depth of the screw head will vary depending on the torque required to drive the screw into the workpiece. In many applications, it is desirable that the top surface of the screw head lie flush with the surface of the workpiece. For example, in decking and floor applications, the screw needs to be countersunk into the planks so that the surface of the deck or floor is smooth.

In another example, screws are used to assemble together framing members in a construction, and then drywall or other workpiece is laid over the framing members. If the screw head does not lie flush with surface of the framing member, this then creates a gap between the framing member and the workpiece when the workpiece is applied. When the framing members are formed of wood, the solution to this problem is typically to countersink the screws into the framing members so that the screws lie flush with the framing members. However, framing members used for example in trusses and other structures of a construction are often formed of metal. It is generally not possible to countersink into a metal member.

Conventionally, this problem has been addressed by providing truss screws with minimal depth heads. However, for higher torque applications, such as self-drilling screws which drill a hole as they are inserted, the screw heads must have a sufficient depth to receive and transfer the torque from the driver. This depth results in unwanted space between the framing receiving the screw and the workpiece such as drywall applied over the framing member.

### SUMMARY OF THE INVENTION

The present invention, roughly described, relates to a truss screw for use in fastening framing members together. In embodiments, the truss screw includes a raised recess section having walls extending from a top surface of the screw head. The walls define a recess, for example a square recess, shaped to receive a screw driving instrument such as a No. 3 square bit.

The thickness and height of the walls of the raised recess section serve at least two functions. First, they are sufficient to receive the torque exerted on screw head from the driving tool to drive the screw into a framing member. Second, the thickness and height of the walls are provided so that they may sink into the back surface of a workpiece applied over the framing member, thus minimizing the space between the framing member and workpiece.

### BRIEF DESCRIPTION OF THE DRAWINGS

FIG. 1 is a perspective view of a truss screw according to embodiments of the present invention.

FIG. 2 is a side view of a truss screw according to embodiments of the present invention.

FIG. 3 is a top view of a truss screw according to embodiments of the present invention.

FIG. 4 is an enlarged side view of a head portion of a truss screw according to embodiments of the present invention.

FIG. 5 is an enlarged side view of a head portion of a truss screw according to an alternative embodiment of the present invention.

FIG. 6 is a cross sectional view of a construction using truss screws according to embodiments of the present invention.

### DETAILED DESCRIPTION

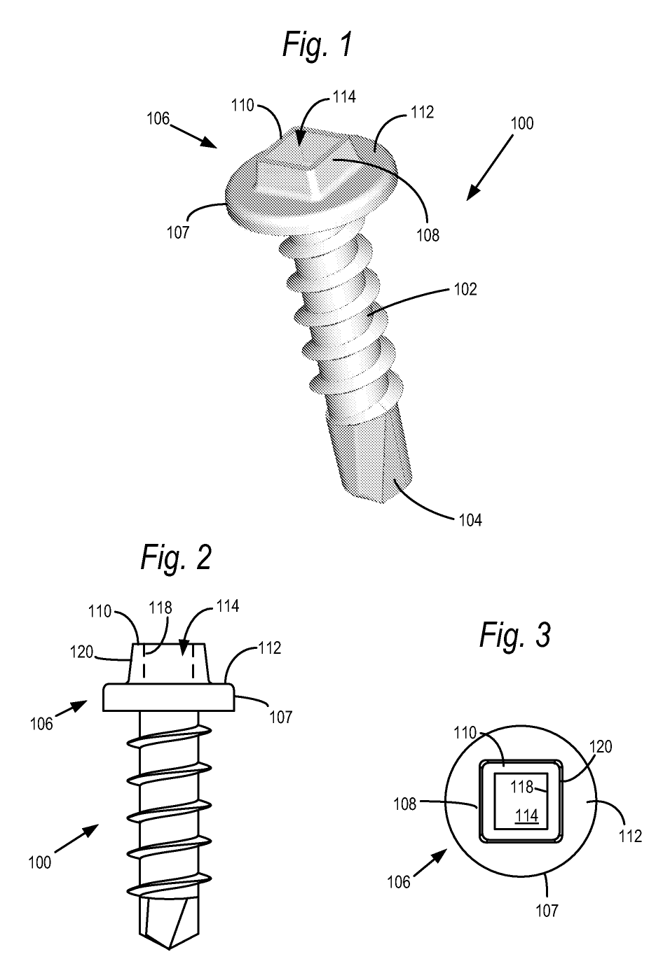

The present invention will now be described with reference to FIGS. 1 through 6 which embodiments relate to a truss screw having a head including a raised recess section. The present invention may, however, be embodied in many different forms and should not be construed as being limited to the embodiments set forth herein; rather these embodiments are provided so that this disclosure will be thorough and complete and will fully convey the invention to those skilled in the art. Indeed, the invention is intended to cover alternatives, modifications and equivalents of these embodiments, which will be included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details. In other instances, well known methods, procedures and components have not been described in detail as not to unnecessarily obscure aspects of the present invention.

Referring now to FIGS. 1 through 3, there is shown a truss screw 100 including a shank 102, a self drilling tip 104 and a head 106 opposite tip 104. Screw 100 may for example be formed of steel, such as C1018 or the like, and may have a length of 0.75 inches. It is understood that the screw 100 may be longer or shorter than that in alternative embodiments. Head 106 may have annular base portion 107 having a diameter of conventional truss screws, such as for example approximately 0.3 inches, though the diameter of the head may be greater than or lesser than that in alternative embodiments. Base portion 107 may be substantially flat with a minimal thickness, and is provided as a stop to prevent screw 100 from being driven completely through one or more of the workpieces.

The shank 102 may have a diameter of 0.13 inches, though it may be larger or smaller than that in alternative embodiments. Shank 102 may include threads having a pitch of between 12 and 18 threads per inch, but it is understood that the threads may have a higher or smaller pitch than that in alternative embodiments. The outer diameter of threads 112 may be 0.19 inches in embodiments of the invention. It is understood that the outer diameter of the threads may vary from that in further embodiments of the invention. The drill tip 104 may be a No. 2 drill point, but it may be other types of drill tips in alternative embodiments. The drill tip 104 may also be omitted in alternative embodiments.

Head 106 includes a raised, recessed section 108 including walls 110 extending from a top surface 112 of the head 106. The walls 110 define a recess 114 shaped to receive a screw driving instrument as explained hereinafter. In embodiments, screw head 106 may include four raised walls 110 defining a square recess 114 for receiving a No. 3 square bit. It is understood that the walls 110 may define other shaped recesses 114 for receiving other shaped and sized screw bits in alternative embodiments.

The walls 110 may extend between 0.05 inches and 0.1 inches above the surface 112, and more particularly about 0.06 inches above the surface 112. The walls may have an average thickness, over their height, of between 0.05 inches and 0.08 inches, and more particularly about 0.07 inches. It is understood that the height the walls 110 above surface 112 and/or the thickness of the walls may vary above or below that range in alternative embodiments. The requirement for the height and thickness of the walls is that the height and thickness of the walls together be sufficient to receive the torque exerted on screw head 106 from the driving tool and transmit the torque to the shank 102 as explained hereinafter. It is also a requirement for the height and/or thickness of the walls 110 that they not be too large to prevent them from sinking into the back surface of the workpiece as explained hereinafter. This will depend in part on the workpiece with which the screw 100 is to be used.

As shown in FIGS. 2 and 3, each wall 110 may have an interior surface 118 defining the recess 114 and an exterior surface 120 opposite the interior surface 118. In embodiments, the exterior surface 120 may taper slightly outward from top to bottom, such as for example 1° to 5° , though the exterior surface may be substantially straight (perpendicular to top surface 112) in alternative embodiments. Interior surface 118 may be substantially straight, though it may taper slightly outward from top to bottom in alternative embodiments.

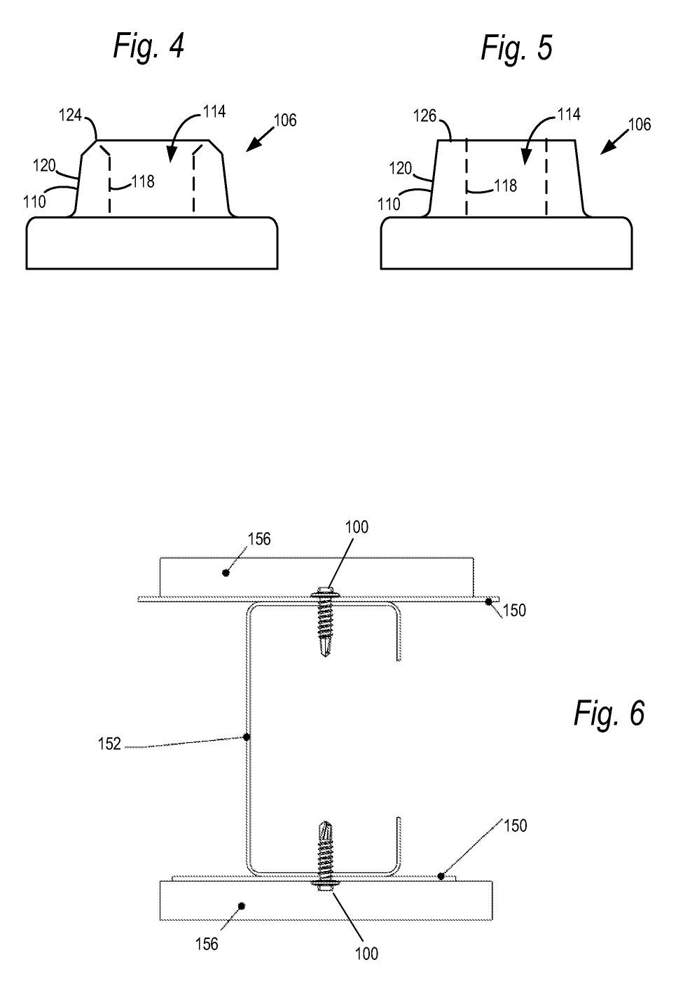

FIGS. 4 and 5 show enlarged views of the head 106 shown in FIG. 2, according to a pair of alternative embodiments. In FIG. 4, the upper edges of the interior and exterior surfaces 118, 120 may taper toward each other to define a sharp crest 124 around the periphery of the raised walls 110 where the interior and exterior surfaces come together. In FIG. 5, the upper edges of the interior and exterior surfaces 118, 120 may be spaced from each other to define a small flat section 126 around the periphery of the raised walls 110 between the upper edges of the interior and exterior surfaces. In FIG. 5, the width of flat section 126 is preferably small enough so as to sink into the back surface of an applied workpiece as explained hereinafter. This will depend in part on the workpiece with which the screw 100 is to be used. Instead of being flat, section 126 may alternatively be rounded.

The operation of screw 100 with the raised recess section 108 will now be explained with reference to FIG. 6. FIG. 6 illustrates a cross section of a portion of a construction including a pair of planar truss members 150 screwed to a central truss member 152 via a pair of screws 100 according to the present invention as described above. It is understood members 150 and 152 may be members other than truss members. Members 150 and 152 may be metal, but need not be metal in alternative embodiments.

Two screws 100 are shown by way of example, and varying numbers of screws may be used. The screws 100 may be driving in with a known bit, for example with an automated screw gun (not shown), using for example a No. 3 square screw bit. As explained above, the screw bit is received within the raised recess 108. Having raised walls of a thickness and height as described above, the recessed section is capable of receiving any torque necessary to drive the screws 100 through the members 150 and 152.

After screws 100 are affixed through members 150 and 152, workpieces 156 are then affixed to planar truss members 150 by fasteners (not shown). Workpieces 156 may for example be drywall, but may be any workpiece which may be fit over members fastened together with screws 100. In accordance with embodiments of the present invention, the walls 110 of the raised recesses 108 sink into the back surface of workpieces 156 (the surface of workpieces 156 adjacent planar members 150) as the workpieces 156 are affixed to members 150. A force may be applied to the workpieces at locations positioned over the screws 100 to ensure that the raised recesses 108 sink into the workpiece.

In embodiments, the walls 110 sink entirely into the workpiece 156. Thus, the only space between planar members 150 and workpieces 156 is the thickness of the annular base 107 of screw head 106. As explained above, the thickness of base 107 is minimal. It is understood that the walls 110 need not sink entirely into the workpieces 156 in alternative embodiments. The walls 110 may sink only partially into the workpieces 156 and still provide advantages over conventional designs.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A screw comprising:
a shank for being received within a member; and
a head affixed to the shank, the head including a plurality of walls defining an interior recess for receiving a driving mechanism, the walls capable of sinking into a workpiece received over the member.

2. A screw as recited in claim 1, the plurality of walls defining a square interior recess.

3. A screw as recited in claim 2, the square interior recess capable of mating with a No. 2 square screw bit.

4. A screw as recited in claim 1, the plurality of walls each including an interior surface and an exterior surface, the interior and exterior surfaces tapering toward each other at their top edges and coming together at a sharp crest.

5. A screw as recited in claim 1, the plurality of walls each including an interior surface and an exterior surface, the interior and exterior surfaces spaced from each other at their top edges by a flat section extending between the interior and exterior surfaces.

6. A screw as recited in claim 1, the plurality of walls each including an interior surface and an exterior surface, the interior and exterior surfaces spaced from each other at their top edges by a rounded section extending between the interior and exterior surfaces.

7. A screw as recited in claim 1, the plurality of walls each including an interior surface and an exterior surface, the interior surface being substantially parallel to an axis of the shank.

8. A screw as recited in claim 1, the plurality of walls each including an interior surface and an exterior surface, the interior surface tapering inward from a bottom nearest the shank to a top.

9. A screw as recited in claim 1, the plurality of walls each including an interior surface and an exterior surface, the exterior surface being substantially parallel to an axis of the shank.

10. A screw as recited in claim 1, the plurality of walls each including an interior surface and an exterior surface, the exterior surface tapering inward from a bottom nearest the shank to a top.

11. A screw as recited in claim 1, the screw further comprising a drill tip at an end of the shank opposite the head.

12. A screw for being received in a member, the member receiving a workpiece thereover, the screw comprising:
a shank;
a head affixed to the shank, the head including a plurality of walls defining an interior recess for receiving a driving mechanism, the walls having a width allowing the walls to sink into the workpiece when the workpiece is received over the member.

13. A screw as recited in claim 12, the plurality of walls defining a square interior recess.

14. A screw as recited in claim 12, the plurality of walls each including an interior surface and an exterior surface, the interior and exterior surfaces tapering toward each other at their top edges and coming together at a sharp crest.

15. A screw as recited in claim 12, the plurality of walls each including an interior surface and an exterior surface, the interior and exterior surfaces spaced from each other at their top edges by a flat section extending between the interior and exterior surfaces.

16. A screw as recited in claim 12, the plurality of walls each including an interior surface and an exterior surface, the interior and exterior surfaces spaced from each other at their top edges by a rounded section extending between the interior and exterior surfaces.

17. A screw comprising:
a shank for being received within a member; and
a head affixed to the shank, the head including:
an annular base portion, and
four walls extending from the annular base portion, the four walls defining a square interior recess for receiving a square driving mechanism, the walls capable of sinking into a workpiece received over the member.

18. A screw as recited in claim 17, the square interior recess capable of mating with a No. 2 square screw bit.

19. A screw as recited in claim 17, the four of walls each including an interior surface and an exterior surface, the interior and exterior surfaces tapering toward each other at their top edges and coming together at a sharp crest.

20. A screw as recited in claim 17, the four walls each including an interior surface and an exterior surface, the interior and exterior surfaces spaced from each other at their top edges by a flat section extending between the interior and exterior surfaces.

21. A screw as recited in claim 17, the four walls each including an interior surface and an exterior surface, the interior and exterior surfaces spaced from each other at their top edges by a rounded section extending between the interior and exterior surfaces.

22. A method of forming a construction, comprising the steps of:
(a) driving a screw through a member using a driving device engaged with a head of the screw;
(b) affixing a workpiece over the member; and
(c) sinking the head of the screw into the workpiece to allow the workpiece to lie substantially flat against the member.

23. A method of forming a construction as recited in claim 22, said step (a) of driving a screw through a member using a driving device engaged with a head of the screw comprises the step of driving a screw using a square bit.

24. A method of forming a construction as recited in claim 22, said step (c) of sinking the head of the screw into the workpiece comprising the step of sinking walls formed on the screw head into the workpiece.

25. A method of forming a construction as recited in claim 24, said step (c) of sinking the head of the screw into the workpiece comprising the step of sinking a sharp crest of the walls into the workpiece.

26. A method of forming a construction as recited in claim 24, said step (c) of sinking the head of the screw into the workpiece comprising the step of sinking a flat upper edge of the walls into the workpiece.

27. A method of forming a construction as recited in claim 24, said step (c) of sinking the head of the screw into the workpiece comprising the step of sinking a rounded upper edge of the walls into the workpiece.
